(19) United States
(12) Patent Application Publication
(10) Pub. No.: US 2008/0100418 A1
(43) Pub. Date: May 1, 2008

(54) Device for identifying and storing objects comprising identification carriers

(76) Inventors: Anatoli Stobbe, Barsinghausen (DE); Wilfried Herrmann, Hannover (DE)

Correspondence Address: COLLARD & ROE, P.C., 1077 NORTHERN BOULEVARD, ROSLYN, NY, 11576, US

(21) Appl. No.: 11/591,353

(22) Filed: Nov. 1, 2006

(51) Int. Cl. B60R 25/00

(52) U.S. Cl. 340/5.73; 340/572.1; 340/5.6; 70/278.2

(57) ABSTRACT

A device for identifying and storing objects having identification carriers has accommodation wells for the objects, combined with antennae of a reading unit. Each accommodation well has a protection device that is controlled by an evaluation- and control circuit of the reading unit. If, after reading and evaluating identification carrier data of the object, the device determines that the object is authorized, the protection device allows the object in the accommodation well or allows the object to remain in the accommodation well. If the object is not authorized, the protection device prevents the object from being accommodated in the accommodation well or prevents the object from remaining in the accommodation well.

### BACKGROUND OF THE INVENTION

1. Field of the Invention

The invention relates to a device for identifying and storing objects comprising identification carriers.

2. The Prior Art

German Patent Application No. DE 102 18 850 C1 describes a device for identifying and storing at least one object comprising an identification carrier. Objects comprising identification carriers can be inserted in one of the accommodation wells and can be locked. However, it is possible to insert objects into any desired accommodation well and to lock them. In order to allow simpler and clearer tracking of objects, it may be necessary to allocate an exclusive accommodation well to each object and to ensure that only the exclusive accommodation wells can be used for storing the objects allocated to these exclusive accommodation wells.

### SUMMARY OF THE INVENTION

It is therefore an object of the invention to provide a device for identifying and storing objects comprising identification carriers, which device permits insertion of the objects into accommodation wells, or which device permits objects to remain in accommodation wells, only when the objects are authorized, while preventing the above when the objects are unauthorized.

This object is met by a device for identifying and storing objects comprising identification carriers, that has accommodation wells combined with antennae of a reading unit. Each accommodation well has a protection device that is controlled by an evaluation- and control circuit of the reading unit. The protection device, after reading and evaluating identification carrier data of the object, when the object is authorized, allows for accommodation of the object in the accommodation well or allows the object to remain in the accommodation well. When the object is not authorized, the device prevents the object from being accommodated in the accommodation well or prevents the object from remaining in the accommodation well.

An evaluation circuit of the reading unit checks scanned identification carrier data to establish whether the selected accommodation well is allocated to the object and whether storage of the object in the accommodation well is permissible. A protection device controlled by the evaluation circuit allows only the storage of authorized objects in the selected accommodation well, while preventing the storage of unauthorized objects.

Because of the above, the tracking of objects becomes significantly easier. Available or missing objects can thus be controlled directly by way of occupied or free accommodation wells, because there is an exclusive allocation only between the objects and the accommodation well.

The protection device can comprise a blocking element which in the case of an unauthorized object, projects into the accommodation well, and which can be removed from the accommodation well only if the object is authorized.

When the object is not authorized, the insertion of the object into a non-permissible accommodation well is mechanically prevented and indicated to the user by the blocking element. In contrast to this, if the object is authorized, it may be inserted into the accommodation well, and may remain in the accommodation well.

The blocking element can be activated by an electric-motor driven, electromagnetic or piezoelectric actuator.

Because of the above, the blocking element can be activated independently of any optionally present locking device. The blocking element can be mechanically coupled to an actuator of the locking device for the object, and can be activated by the actuator.

As a result of the above, the same actuator can be used both for operating a locking device for the object, and for activating the blocking element. This solution only requires a mechanical blocking element and a spring element, and therefore is not associated with any increase in design space.

The actuator of the locking device can be electric-motor driven, electromagnetic or piezoelectric.

The protection device can also be a spring element that can be tensioned by inserting the object in the accommodation well, which spring element exerts an ejection force onto the object. If the object is not authorized, the object is pushed from the accommodation well by releasing the spring element. If the object is authorized the locking device in the accommodation well is activated and any pushing out of the object by the spring element can be blocked.

This design is particularly easily implementable because only an additional spring element is required. While an object can at first be inserted into any accommodation well, the associated locking device only fastens the object if an authorization is present. In contrast to this, if the object is unauthorized, the object is ejected as soon as it is released.

With a design comprising the locking element, preferably two reading antennae are arranged on the accommodation well, which reading antenna can be coupled to an identification carrier antenna in the object. One reading antenna is positioned such that in a locked position of the object, it is coupled to the identification carrier antenna, while the other reading antenna is positioned such that it is already coupled to an object present at the entry to the accommodation well via the identification carrier antenna of the object.

Because of the above, identification carrier data can be read in both relevant positions. There is no need for an increase in the transmission output or in the receiver sensitivity, Which increase would be necessary if only one reading antenna were used for larger reading distances. Increasing the transmission output or the receiver sensitivity would have a disadvantage in that the spacing from adjacent accommodation wells would have to be increased in order to enable selective reading and in order to prevent inductive disturbance.

The antennae can be designed as two separate coils that enclose the accommodation well, or as one coil that encloses the accommodation well, which coil comprises two separate galvanically connected windings.

In a system for identifying and storing objects comprising identification carriers by means of accommodation wells combined with antennae of a reading unit, the reading units and actuators are connected to a shared evaluation- and control circuit. Furthermore, the evaluation- and control circuit is connected to visual signal transmitters that are allocated to each accommodation well. The evaluation- and control circuit comprises an input device by means of which, by way of automatic reading or manual input of identification carrier data, the visual signal transmitters that are associated with the respective accommodation well can be activated.

Because of the above, by reading or inputting the identification carrier data, the associated accommodation well can be indicated, and the object can be led in a targeted manner to the valid accommodation well.

By means of the input device, it is also possible to enter or change the allocation between accommodation wells and identification carrier data of the objects.

Furthermore, the evaluation- and control circuit can be connected to a monitoring system that based on the allocation of objects and accommodation wells, registers the presence or absence of objects.

With security-relevant facilities or equipment it is possible with the invention, by way of the presence or absence of objects that have to be carried along by personnel employed in such facilities, to register the presence or absence of the personnel. Typical applications include industrial, scientific or military facilities which may only be operated if nobody is present in the danger zone of the facility.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows an accommodation well with a protection device, designed as a plug-in protection, and a locking device; and

FIG. 2 shows an accommodation well with a protection device, designed as an ejection device, and a locking device.

### DETAILED DESCRIPTION OF THE PREFERRED EMBODIMENT

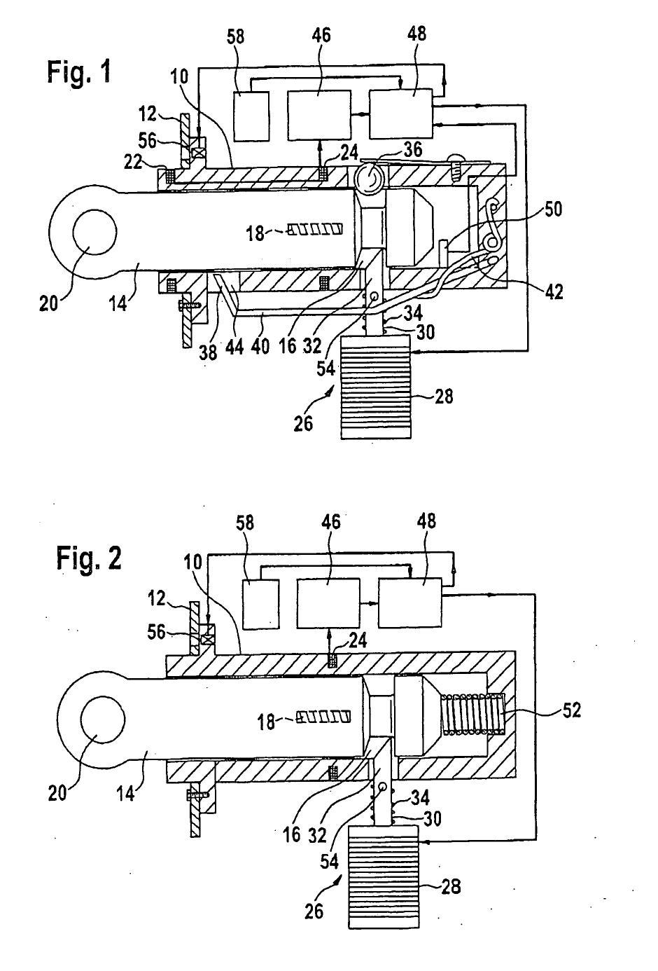

Referring now in detail to the drawings, FIG. 1 shows an accommodation well 10, attached to a front plate 12 of the housing of a storage device with an insertion protection and a locking device. At the front of accommodation well 10 a visual signal transmitter 56 is arranged, which, in the case of several possible accommodation wells, signals to the user which accommodation well is valid for accommodation or removal of objects. In accommodation well 10 an object 14 has been inserted and locked. Accommodation well 10 and object 14 are cylindrical in shape. The end of object 14, which end is shown on the right-hand side of the drawing, is bevelled, and spaced apart from this end there is a circumferential ring groove 16. Within object 14, an identification carrier with an antenna coil 18 is arranged, with the axis of said antenna coil 18 being aligned parallel in relation to the longitudinal central axis of object 14. The end of object 14, shown on the left side of the drawing, comprises at least one borehole 20, which is, for example, suitable for accommodating a key ring or a wire loop with keys attached thereto.

Accommodation well 10 is enclosed by a cylindrical coil comprising two windings 22, 24 located in coil chambers, which windings 22, 24 are used as a reading antenna for the non-contacting reading of identification carrier data of the object. A first coil chamber with a first winding 22 is arranged in the entrance region of accommodation well 10, in front of front plate 12, while a second coil chamber with a second winding 24 is arranged in the middle region of the accommodation well 10, behind front plate 12.

By arranging separate windings 22, 24 of the reading antenna, identification carrier data of an object 14 can be read and evaluated both in a position of the object directly in front of accommodation well 10, and in a position within accommodation well 10.

The locking device comprises an electromagnetic actuator 26 comprising a magnet coil 28 and an armature 30. Armature 30 continues outside magnet coil 28 as a locking pin 32, with the face of armature 30 being bevelled. In the state where no current is applied to actuator 26, locking pin 32 is pushed into accommodation well 10 by a spring 34, engages the circumferential groove (ring groove) 16 of object 10 and thus assumes a locking position. In the state where current is applied to actuator 26, the force of spring 34 is overcome and locking pin 32 is pulled downwards from accommodation well 10 and assumes an unlocked position. Because of the above, object 14 is freely movable in accommodation well 10 and can be pulled out.

As a result of its bevelled right-hand end, when object 14 is inserted in accommodation well 10, object 14 can push locking pin 32 out of accommodation well 10 by way of the bevelled front of locking pin 32, without current having to be applied to electromagnetic actuator 26 for this purpose. When object 10 has reached its end position, locking pin 32 springs back as a result of the force of spring 34, before engaging ring groove 16 of object 14.

A spring-loaded ball 36 on accommodation well 10, which ball 36 also engages ring groove 16, fixes the position of object 14 in accommodation well 10 such that locking pin 32 does not come to rest against a flank of ring groove 16 of object 10 and thus cannot block, by frictional engagement, locking pin 32 and thus armature 30.

In applications where insertion of an object in an incorrect accommodation well is to be prevented, while the object in the correct accommodation well is not to be locked, a locking pin is not required. In this case, spring-loaded ball 36, which engages ring groove 16, merely fastens the object to accommodation well 10. Such a design makes it possible to quickly remove the objects in case of an emergency, e.g. in applications associated with firefighting or emergency services activities. In such applications, it is of crucial importance that in the case of a call-out, the objects are in the correct accommodation wells.

At the end of the accommodation well 10 there is an insertion switch 50 that is operated by inserted object 14 so as to signal the presence of an object 14 in accommodation well 10.

Accommodation well 10 further comprises a protection device with a blocking element 38 that prevents the insertion of unauthorized objects while allowing the insertion of authorised objects. Blocking element 38 comprises a transverse leg that points approximately perpendicularly in relation to the longitudinal axis of accommodation well 10 and is arranged on a longitudinal leg 40 that in turn is swivellably held on the housing of accommodation well 10 and is pre-tensioned by a spring 42. By swivelling longitudinal leg 40 inwards, blocking element 38 enters accommodation well 10 by way of a slit 44 in the front region of accommodation well 10, thus assuming a locked position. By swivelling longitudinal leg 40 outwards, blocking element 38 leaves accommodation well 10, thus assuming a release position.

Longitudinal leg 40 is coupled on one side to electromagnetic actuator 26. In the state where current is applied to actuator 26, engaging pins 54 of armature 30 grip longitudinal leg 40 from behind and swivel it outwards. Blocking element 38 assumes the released position. If, subsequently, an object 14 is inserted in accommodation well 10, blocking element 38 remains in the released position because return into the blocked position is blocked by object 14. In contrast to this, when no current is applied to actuator 26, armature 30 can return to the locked position as a result of the force of its spring 34, and locking pin 32 can engage ring groove 16 of object 14 as soon as object 14 has been fully inserted into accommodation well 10.

Control of actuator 26 and of visual signal transmitter 56 takes place via an evaluation-and control circuit 48 that is connected to a reading unit 46. Prior to the return of an object 14, by way of an input device 58 that is connected to evaluation- and control device 48, the identification carrier data of the object 14 is entered. This can be effected by manual input or by automatic reading of the identification carrier data by an additional reading unit on input device 58. After evaluation of the identification carrier data, by way of the evaluation- and control circuit 48, visual signal transmitter 56 of the allocated accommodation well 10 is activated. As soon as object 14 is subsequently held in front of the opening of the accommodation well 10, by way of first winding 22 of the reading antenna, identification carrier data of object 14 is read and evaluated. This additional evaluation is to ensure that the object held in front of the opening of accommodation well 10 is the same object whose identification carrier data has previously been entered by way of input device 58, rather than it being some other object 14.

If the object is authorized, current is applied to the actuator associated with accommodation well 10, and blocking element 38 is moved to the release position. Object 14 can then be inserted into accommodation well 10. In the inserted state, by way of second winding 24 of the reading antenna, identification carrier data of object 14 is again read and evaluated.

If authorization is confirmed, no current is applied to actuator 26, and locking pin 32 can engage ring groove 16 of object 14. Otherwise, e.g. in the case of an exchange of the object originally read in front of accommodation well 10 by some other inserted object, current is applied to actuator 26, and an alarm is issued. The object must be removed from accommodation well 10 if the alarm is to be cleared.

In order to release an object 14, which release can be initiated by entering an authorization code via an input device for example, current is applied to actuator 26 so that locking pin 32 comes out of ring groove 16 and takes up an unlocked position. At the same time, visual signal transmitter 56 is activated in order to show the user the applicable accommodation well 10. The released object 14 can then be removed from accommodation well 10 within a predefinable period of time.

If object 14 is not removed, the current supply to actuator 26 is terminated, and locking pin 32 again engages ring groove 16. If object 14 is removed, which can be monitored by way of the position of insertion switch 50 and by reading the identification carrier data via second winding 24 of the reading antenna, the current supply to actuator 26 ceases immediately. After object 14 has been withdrawn from accommodation well 10, blocking element 38 can then immediately assume its blocked position again, thus preventing any insertion of unauthorized objects in accommodation well 10.

A bevelled surface on the rear of blocking element 38 is used to prevent blocking of object 14 during withdrawal, by swivelling blocking element 38 into ring groove 16. While the bevelled surface slides along the flank of ring groove 16, blocking element 38 temporarily swivels to the outside, thus clearing the way. Subsequently, as a result of the force of spring 42, blocking element 38 swivels inwards again.

In the design according to FIG. 2, the protection device comprises a spring element 52 that can be tensioned by inserting object 14 in accommodation well 10. In this arrangement, spring element 52 is axially aligned with accommodation well 10, is supported on the rear of accommodation well 10, and in its released state projects a considerable distance into accommodation well 10. In this arrangement, the reading antenna comprises only one winding 24 in the middle region of accommodation well 10.

Irrespective of its authorization, an object 14 can at first be inserted into accommodation well 10. In a position in which data interchange between an identification carrier antenna 18 and only winding 24 of reading antenna is possible, identification carrier data of object 14 is read and evaluated.

If the object is not authorized, current is applied to actuator 26 so that locking pin 32 assumes its unlocked position, and object 14 when released is subsequently pushed out of accommodation well 10 by the relaxing spring element 52. If the object is authorized, no current is applied to actuator 26, and after object 14 has been fully inserted into accommodation well 10, locking pin 32 can engage ring groove 16, thus fastening object 14.

In order to release an object 14, which release is for example also initiated by entering an authorization code by way of an input device, current is applied to actuator 26. However, since as a result of the force of spring element 52 acting on the object 14 one flank of ring groove 16 is pressed against locking pin 32, thus blocking armature 30 as a result of frictional engagement, object 14 at first remains fastened. However, by further pressing object 14 into accommodation well 10 beyond the fastened position, frictional engagement ceases so that armature 30 can attract, and locking pin 32 can move out ring groove 16 and assume its unlocked position. Object 14 can then be removed from accommodation well 10, or if let go would automatically be pushed out of accommodation well 10.

Furthermore, by means of input device 58, the allocation between accommodation wells 10 and identification carrier data of objects 14 is entered. In this way an allocation can be brought about or changed that is clear and easily comprehensible to users and user groups alike.

The evaluation- and control circuit 48 can also be connected to, or form part of, a higher-order monitoring system. For example, the presence or absence of personnel that is engaged in industrial, scientific or military plant has to be monitored. If this personnel for access authorization to hazardous areas have to carry the above-mentioned object with them, and after leaving said hazardous areas have to return said objects by inserting then into the accommodation wells of the device, then it is possible, by way of tracking the presence or absence of the objects, to track the presence or absence of personnel.

A security device can then monitor the presence or absence of personnel, and can release a plant for operation only when there are no longer any personnel present in the hazardous region.

Accordingly, while only a few embodiments of the present invention have been shown and described, it is obvious that many changes and modifications may be made thereunto without departing from the spirit and scope of the invention.

What is claimed is:

1. A device for identifying and storing objects having identification carriers, comprising:
at least one accommodation well;
a reading unit connected to said accommodation well and having an evaluation- and control circuit; and
a protection device associated with said accommodation well, said protection device being controlled by the evaluation- and control circuit of the reading unit,
wherein said evaluation- and control circuit of the reading unit reads and evaluates identification carrier data of an object inserted into the accommodation well to determine if the object is authorized or not authorized, and wherein the protection device allows the object to be accommodated in the accommodation well or allows said object to remain in the accommodation well if the object is authorized, and prevents the object from being accommodated in the accommodation well or prevents said object from remaining in the accommodation well if the object is not authorized.

2. The device according to claim 1, wherein the protection device comprises a blocking element which projects into the accommodation well if the object is not authorized, and is removable from the accommodation well only if the object is authorized.

3. The device according to claim 2, wherein the blocking element is activated by an electric-motor driven, electromagnetic or piezoelectric actuator.

4. The device according to claim 2, wherein the blocking element is mechanically coupled to and activated by an actuator of a locking device for the object.

5. The device according to claim 4, wherein the actuator of the locking device is electric-motor driven, electromagnetic or piezoelectric.

6. The device according to claim 1, wherein the protection device comprises a spring element that is tensioned by inserting the object in the accommodation well, said spring element exerting an ejection force onto the object, wherein the object is pushed out of the accommodation well by releasing the spring element when the object is not authorized, and a locking device in the accommodation well blocks said object against being pushed out by the spring element when the object is authorized.

7. The device according to claim 2, wherein the reading unit comprises two reading antennae arranged on said accommodation well, one of said reading antennae being coupled to an antenna coil of the identification carrier when the object is in a locked position, and the other one of said reading antennae being coupled to the antenna coil of the identification carrier when the object is located at an entry to the accommodation well.

8. The device according to claim 7, wherein the antennae are two separate windings that enclose the accommodation well.

9. The device according to claim 7, wherein the antennae are designed as one coil that encloses the accommodation well, which coil comprises two separate galvanically connected windings.

10. A system for identifying and storing objects having identification carriers, comprising:
a plurality of accommodation wells;
antennae of a reading unit connected to each accommodation well;
a shared evaluation- and control circuit connected to said reading unit;
visual signal transmitters connected to said evaluation- and control circuit, said transmitters being allocated one to each accommodation well; and
an input device in the evaluation- and control circuit, said input device activating said visual signal transmitters by automatic reading or manual input of identification carrier data.

11. The system according to claim 10, wherein allocation between accommodation wells and identification carrier data of the objects are entered or changed via said input device.

12. The system according to claim 10, wherein the evaluation- and control circuit is connected to a monitoring system that registers the presence or absence of objects based on an allocation of objects and accommodation wells.
